(19) United States
(12) Patent Application Publication
(10) Pub. No.: US 2026/0321487 A1
(43) Pub. Date: Oct. 15, 2026

(54) COIL DEVICE

(71) Applicant: TDK Corporation, Tokyo (JP)

(72) Inventors: Hiroki YAMANE, Tokyo (JP); Tomohiro FURUICHI, Tokyo (JP); Hideaki HARATA, Tokyo (JP)

(73) Assignee: TDK Corporation, Tokyo (JP)

(21) Appl. No.: 19/553,791

(22) Filed: Mar. 2, 2026

(30) Foreign Application Priority Data
Mar. 3, 2025 (JP) 2025-032889

(51) Int. Cl. H01F 27/32; H01F 27/28; H01F 27/29

(52) U.S. Cl. CPC H01F 27/325; H01F 27/2823; H01F 27/29

(57) ABSTRACT

A bobbin 3 includes a terminal mounting portion 36a in which a terminal 9 is embedded. The bobbin 3 also includes a first mounting-side protrusion 38 having a first protrusion end face 39 that is positioned closer to an object 12 on which a coil device is to be mounted than a closest surface 36b of the terminal mounting portion 36a, the closest surface 36b being the surface of the terminal mounting portion 36a that is closest to the object 12. The first protrusion end face 39 functions as a bonding surface for bonding to the object 12.

### TECHNICAL FIELD

The present disclosure relates to a coil device that may be used in a transformer or other devices.

### BACKGROUND

In existing coil devices, such as one disclosed in Patent Document 1, a terminal mounting portion on which a terminal is mounted is a portion of a bobbin that is positioned closest to a circuit board or an object on which the coil device is mounted. A mounting-side terminal extends from the terminal mounting portion toward the board.

The coil device is typically fixed to the board by connecting the mounting-side terminal to a land portion or the like on the board.

However, the present inventors have found the following drawbacks in the structure of existing coil devices. The existing coil device and the board may be insufficiently bonded, and the fixing strength may be inadequate when the coil device is mounted on a portion of the board where severe vibrations occur.

### PATENT DOCUMENT

Patent Document 1: JP Patent Application Laid Open No. 2021-136261

### SUMMARY

An object of the present disclosure is to provide a coil device having a structure that exhibits excellent fixing strength when mounted on an object.

In order to achieve the above-mentioned object, a coil device according to one aspect of the present disclosure includes:
a bobbin including a tubular portion, a wire being wound around a tubular portion; and
a terminal connected to an end of the wire wound around the tubular portion, wherein
the bobbin includes a terminal mounting portion to which the terminal is attached,
the bobbin includes a first mounting-side protrusion having a first protrusion end face located closer to an object on which the coil device is to be mounted than a closest surface of the terminal mounting portion that is closest to the object, and the first protrusion end face functions as a bonding surface for bonding to the object.

The coil device includes the first mounting-side protrusion having the first protrusion end face that is configured to be positioned closer to the object on which the coil device is to be mounted (i.e., circuit board) than the closest surface of the terminal mounting portion, the closest surface being the surface of the terminal mounting portion that is closest to the object. Thus, it is possible to fix the gap between the first protrusion end face and the object with an adhesive. This reinforces the electrical connection between the mounting portion of the terminal and a land pattern or the like on the object, thereby improving the fixing strength therebetween. Accordingly, even when the coil device is used in a portion where severe vibrations are applied, reliable connection of the coil device is maintained. In addition, the bonding strength for bonding to the object is sufficiently high during reflow and after the coil device is mounted on a board, and therefore, the coil device is maintained at the correct position.

Preferably, the first protrusion end face protrudes outward toward the object on which the coil device is to be mounted beyond the terminal mounting portion that holds a mounting portion of the terminal.

The mounting portion of the terminal may include a bent portion protruding from the terminal mounting portion and a slope portion extending from the bent portion to a tip of the bent portion and inclined in a direction away from the terminal mounting portion. Preferably, a tip of the mounting portion protrudes toward the object on which the coil device is to be mounted beyond the protrusion end face. With this structure, when the mounting portion of the terminal is connected to a land pattern of the object by soldering, conductive adhesive, or the like, the protrusion end face can be easily bonded to a portion other than the land pattern of the object with an adhesive.

Preferably, the tip of the mounting portion protrudes beyond the first protrusion end face toward the object on which the coil device is to be mounted, so as to become flush with the first protrusion end face when subjected to an external force. For example, the terminal may be made of a conductive metal member. Thus, the mounting portion of the terminal is made elastic, and the tip of the mounting portion can become flush with the first protrusion end face due to the elasticity of the mounting portion when subjected to an external force.

The first protrusion end face may protrude beyond the bent portion toward the object on which the coil device is to be mounted. With this structure, the tip of the mounting portion can slightly protrude toward the object beyond the first protrusion end face.

A terminal base may be integrally formed with the bobbin and have the terminal mounting portion. The first mounting-side protrusion may be formed on the terminal base at an end portion along a longitudinal direction of the terminal base. With this structure, the position where the terminal is connected to a land pattern or the like on the object and the position where the first mounting-side protrusion of the bobbin is bonded to the object can be easily made different from each other, which facilitates each connection step.

Preferably, the coil device further includes a cover that covers a non-mounting-side outer circumference of a wound portion of the wire wound around the tubular portion. Preferably, the cover includes a second mounting-side protrusion that protrudes beyond a mounting-side outer circumference of the wound portion of the wire toward the object. The second protrusion end face of the second mounting-side protrusion can also function as a bonding surface for bonding to the object as with the first protrusion end face, thereby further improving the bonding strength for bonding to the object.

Preferably, the second protrusion end face of the second mounting-side protrusion is arranged to be substantially flush with the first protrusion end face. The state of being substantially flush means that a slight deviation is acceptable within a manufacturing tolerance.

The first protrusion end face is formed on the bobbin, for which manufacturing errors are relatively more strictly controlled compared with the cover. Thus, in order to reliably bond the first protrusion end face to the object, the first protrusion end face may protrude toward the object beyond the second protrusion end face. Alternatively, in view of reliably bonding the second protrusion end face to the object, the second protrusion end face may protrude toward the object beyond the first protrusion end face.

Preferably, the second protrusion end face is arranged adjacent to the first protrusion end face. This arrangement enables the continuous formation of bonding surfaces on the second protrusion end face and the first protrusion end face, thereby improving the bonding strength.

The total area of the second protrusion end faces may be larger than the total area of the first protrusion end faces. The cover covers the non-mounting-side portions of the bobbin, and therefore, portions of the cover positioned in spaces formed between portions forming the bobbin can be used as the second protrusion end faces. This enables easily increasing the area of the second protrusion end face.

Preferably, the second mounting-side protrusion includes corner protrusions, each provided at a corresponding one of four corners of the cover. With this structure, a reliable bonding surface is easily formed on the cover while saving space without increasing the dimensions of the coil device.

Preferably, the second mounting-side protrusion also includes a central protrusion positioned between a pair of the corner protrusions arranged along a core axis of the wound portion of the wire. In addition, a portion of the first mounting-side protrusion is preferably arranged between the central protrusion and one of the pair of corner protrusions. With this structure, a continuous bonding surface is formed in a region where the first protrusion end face and the second protrusion end face are alternately arranged, along the core axis of the wound portion of the wire, thereby improving the bonding strength. Preferably, the second protrusion end face and the first protrusion end face are arranged alternately in a direction parallel to the core axis of the wound portion of the wire.

Preferably, the area of an end face of the central protrusion is larger than the total area of end faces of the corner protrusions and is also larger than the total area of the first protrusion end faces. With this structure, a reliable bonding surface is easily formed on the cover while saving space without increasing the dimensions of the coil device.

A coil device according to another aspect of the present disclosure includes: a bobbin including a tubular portion, a wire being wound around a tubular portion;
a cover covering a non-mounting-side outer circumference of a wound portion of the wire wound around the tubular portion; and
a terminal connected to an end of the wire wound around the tubular portion, wherein
the bobbin includes a terminal mounting portion to which the terminal is attached,
the cover includes a second mounting-side protrusion having a second protrusion end face located closer to an object on which the coil device is to be mounted than a closest surface of the terminal mounting portion that is closest to the object, and
the second protrusion end face functions as a bonding surface for bonding to the object on which the coil device is to be mounted.

In this coil device, the bobbin includes the second mounting-side protrusion having the second protrusion end face that is configured to be positioned closer to the object on which the coil device is to be mounted (i.e., circuit board) than the closest surface of the terminal mounting portion, the closest surface being the surface of the terminal mounting portion that is closest to the object. Thus, it is possible to fix the gap between the second protrusion end face and the object with an adhesive. This reinforces the electrical connection between the mounting portion of the terminal and a land pattern or the like on the object, thereby improving the fixing strength therebetween.

Accordingly, even when the coil device is used in a portion where severe vibrations are applied, reliable connection of the coil device is maintained.

Preferably, the second mounting-side protrusion includes corner protrusions respectively provided at corners of the cover. With this structure, a reliable bonding surface is easily formed on the cover while saving space without increasing the dimensions of the coil device.

Preferably, the second mounting-side protrusion also includes a central protrusion that is positioned between a pair of corner protrusions arranged along a core axis of the wound portion of the wire.

Preferably, the second mounting-side protrusion is integrally formed with a terminal-base covering portion of the cover that covers an upper surface of a terminal base having the terminal mounting portion and is recessed from the terminal-base covering portion toward the object on which the coil device is to be mounted. With this structure, the mechanical strength of the cover is improved, and a second protrusion end face that functions as a bonding surface having a large area is formed, thereby improving the bonding strength.

### BRIEF DESCRIPTION OF THE DRAWINGS

FIG. 1A is a perspective view of a coil device according to one embodiment of the present disclosure.

FIG. 1B is a bottom perspective view of the coil device shown in FIG. 1A.

FIG. 1C is a front view of the coil device shown in FIG. 1A.

FIG. 1C1 is a front view showing details of an assembled portion between the bobbin and the case shown in FIG. 1C.

FIG. 1D is a bottom view of the coil device shown in FIG. 1A.

FIG. 2 is an exploded perspective view of the coil device shown in FIG. 1A.

FIG. 3 is a perspective view of the bobbin and the cover illustrated shown in FIG. 2.

FIG. 4 is a perspective view of the bobbin shown in FIG. 3.

FIG. 5 is a sectional view of a portion of the bobbin taken along line V-V in FIG. 4.

FIG. 6 is an enlarged view of a portion of FIG. 5.

FIG. 7 is a bottom perspective view of a coil device according to another embodiment of the present disclosure.

### DETAILED DESCRIPTION

Hereinafter, embodiments of the present disclosure will be described. The embodiments of the present disclosure are described with reference to the drawings as appropriate; however, the drawings are merely schematic and illustrative for facilitating understanding of the present disclosure, and may not precisely represent the actual appearance, dimensional ratios, and the like. In addition, the present disclosure is specifically described with reference to the following embodiments, but is not limited thereto. For example, other embodiments may be implemented by combining at least a portion of a plurality of embodiments described below.

### First Embodiment

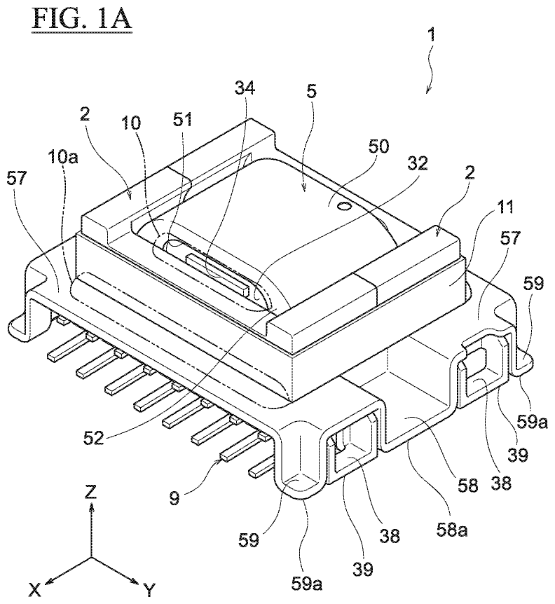

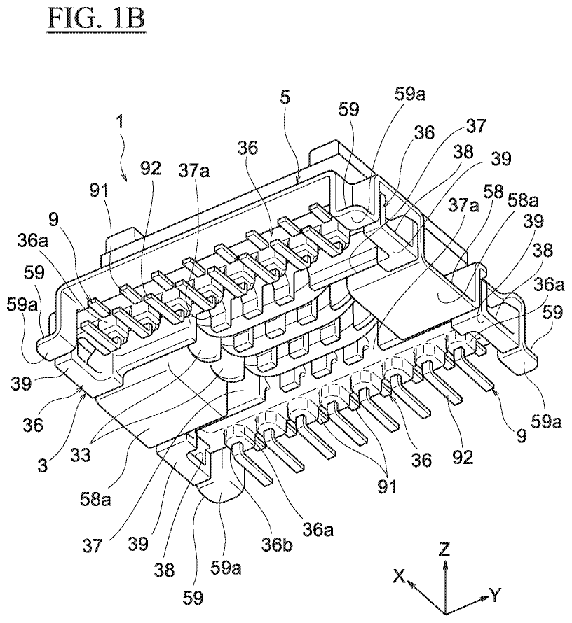

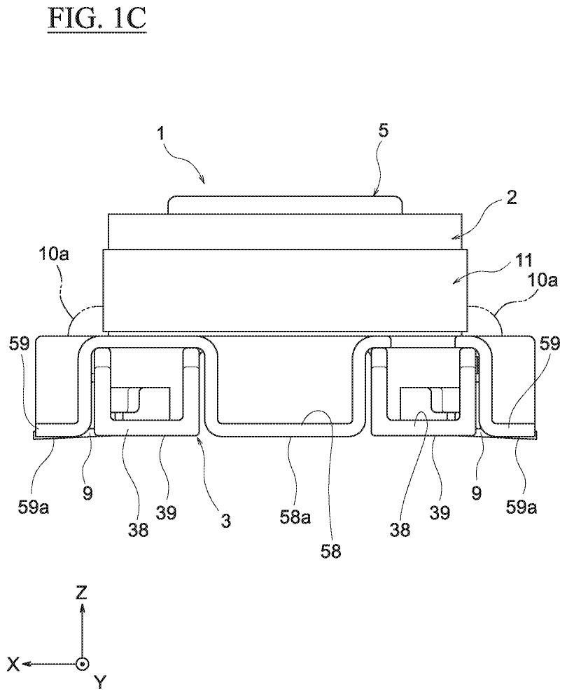

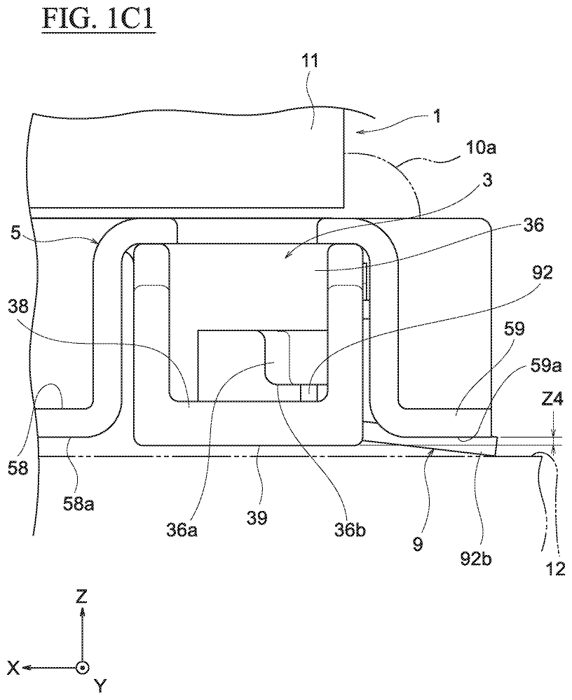

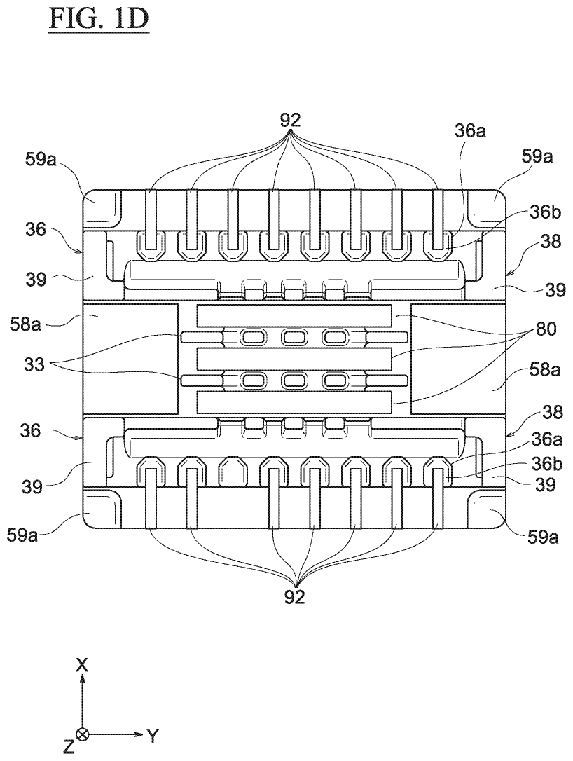

The coil device 1 according to the present embodiment shown in FIGS. 1A to 6 may be used in an on-board charger for electric vehicles (EV), plug-in hybrid vehicles (PHV), commuter vehicles, or the like, and may also be used in power circuits of household or industrial electronic devices or computer devices. The coil device 1 may further be used as a transformer to which a high voltage is applied.

As shown in FIG. 1A, the coil device 1 includes cores (magnetic cores) 2, a bobbin 3, and a cover 5. In the drawings, the X-axis, the Y-axis, and the Z-axis are perpendicular to each other, and the Z-axis corresponds to a height (thickness) direction of the coil device 1. The X-axis is parallel to a winding axis of a wound portion, which will be described later.

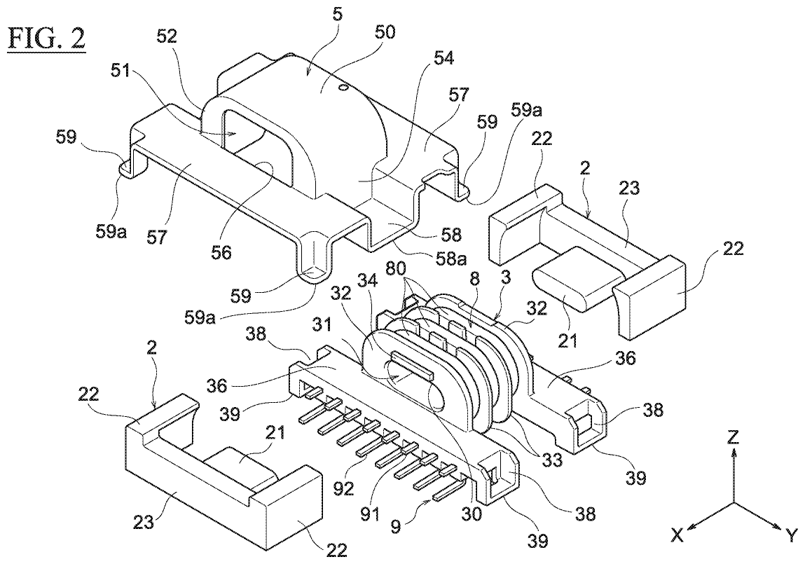

As shown in FIG. 2, the bobbin 3 includes a tubular portion 30 and a pair of terminal bases 36 and 36 that are integrally formed with the tubular portion 30 and that are positioned on opposite sides of the tubular portion 30 in the X-axis direction.

In the present embodiment, the pair of terminal bases 36 and 36 have the same structure; however, the structures thereof are not necessarily the same. For example, the number of terminals 9 embedded in one of the terminal bases 36 may be different from that in the other terminal base 36. In another example, the shapes of the terminals 9 embedded in one of the terminal bases 36 may be different from those of the terminals 9 embedded in the other terminal base 36, and the shapes of the terminal bases 36 may also be different from each other.

The tubular portion 30 of the bobbin 3 includes a winding core portion around which wires 8 are wound and end flanges 32 positioned on both sides of the winding core portion in the X-axis direction. Central flanges 33 are integrally formed on the outer circumference of the winding core portion of the tubular portion 30 between the end flanges 32. The tubular portion 30 has a through hole 31 for receiving leg portions of the cores 2, and the through hole 31 extends in the X-axis direction through the winding core portion on which the end flanges 32 and the central flanges 33 are formed.

In the present embodiment, the cores 2 and 2 have the same shape and have an E-shaped cross section in an X-Y plane, thereby forming a so-called E-shaped core. That is, the cores 2 and 2 each have a base portion 23 extending in the Y-axis direction, a pair of outer leg portions 22 and 22 protruding in the X-axis direction from both ends in the Y-axis direction of the base portion 23, and a central leg portion 21 protruding in the X-axis direction from a central region in the Y-axis direction between the outer leg portions 22 and 22.

In the present embodiment, the central leg portions 21 and 21 are configured to be inserted into the through hole 31 of the bobbin 3 from both sides in the X-axis direction. The tips of the central leg portions 21 and 21 may abut or face each other with a predetermined gap therebetween inside the through hole 31 of the bobbin 3. By providing a gap, leakage characteristics can be adjusted according to the width of the gap.

As shown in FIG. 2, the central leg portions 21 and 21 have an approximately elliptical cylindrical shape corresponding to the inner circumferential surface of the through hole 31. However, the shapes of the central leg portions 21 are not limited thereto and may be modified according to the shape of the through hole 31. The outer leg portions 22 and 22 have shapes corresponding to the end faces in the Y-axis direction of the flanges 32 and 33 and have outer surfaces parallel to an XZ plane (a plane including the X-axis and the Z-axis). In the present embodiment, the material of each core 2 may be a metal or a soft magnetic material such as ferrite, but is not particularly limited.

The terminal bases 36 and 36 each extend outward in the X-axis direction (outward when viewed from the center of the bobbin 3; the same applies hereinafter) from lower portions in the Z-axis direction of the end flanges 32 and 32. Preferably, the upper surface along the Z-axis of the terminal base 36 is lower than the bottom surface of the through hole 31 by a thickness of a terminal-base covering portion 57 of the cover 5, which will be described later. The upper surface of the terminal-base covering portion 57 and the bottom surface of the through hole 31 are preferably configured to be flush with each other. This is because the central leg portion 21 of the core 2 can be smoothly guided from the upper surface of the terminal-base covering portion 57 to the bottom surface of the through hole 31.

In the present embodiment, the widths in the Y-axis direction of the terminal bases 36 and 36 are wider than the widths in the Y-axis direction of the end flanges 32 and 32 and protrude beyond both end surfaces in the Y-axis direction of the end flanges 32 by a predetermined width. The predetermined protrusion amounts along the Y-axis of the terminal bases 36 and 36 from the both end surfaces in the Y-axis direction of the end flanges 32 and 32 are preferably approximately the same as the width in the Y-axis direction of the outer leg portions 22 of the cores 2. The upper surfaces of the terminal bases 36 and 36 are covered by the terminal-base covering portions 57 and 57 of the cover 5, and the cores 2 and 2 are further disposed on the terminal-base covering portions 57. The terminal-base covering portion 57 of the cover 5 increases the insulation distance between the terminals 9 and the core 2, thereby improving the withstand voltage.

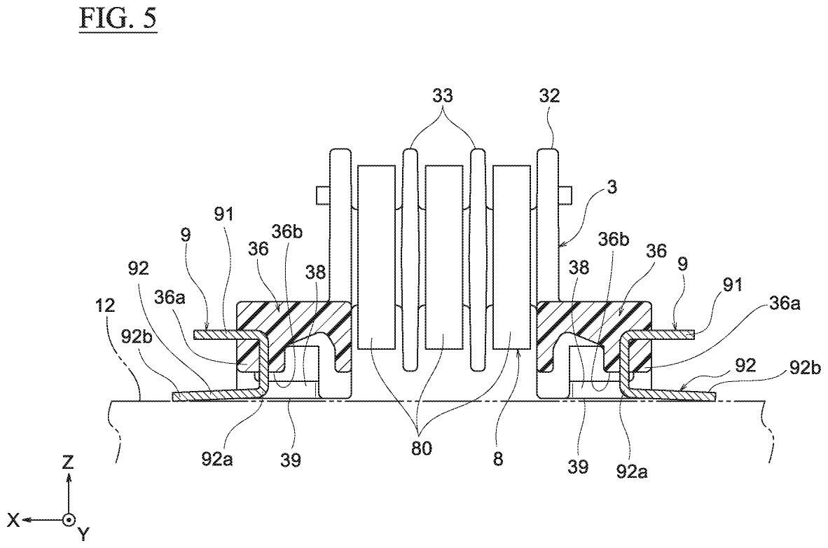

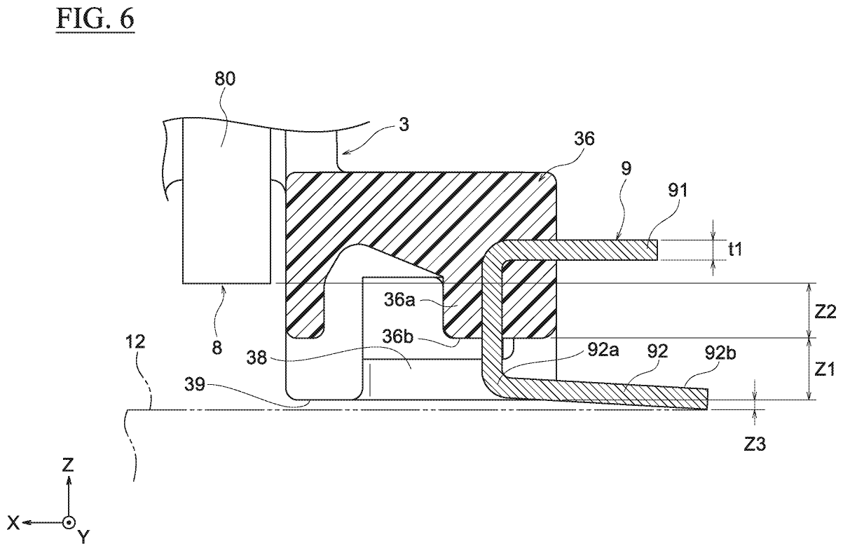

A plurality of terminals 9 are embedded in each of the terminal bases 36 and 36 and are aligned along the Y-axis. As shown in FIG. 1B, each terminal 9 has a wire connection portion 91 and a mounting portion 92, and the terminal 9 is insert-molded into the terminal base 36 of the bobbin 3 such that the portion between the wire connection portion 91 and the mounting portion 92 is embedded in the terminal base 36. More specifically, as shown in FIGS. 5 and 6, the portion between the wire connection portion 91 and the mounting portion 92 of the terminal 9 is insert-molded into a terminal mounting portion 36a that protrudes downward along the Z-axis from the terminal base 36.

The mounting portion 92 is configured to protrude, when mounted, in a direction toward a circuit board 12 from a closest surface 36b of the terminal mounting portion 36a. The closest surface 36b is the surface closest to the circuit board 12 when mounted. The mounting portion 92 has a bent portion 92a protruding from the closest surface 36b of the terminal mounting portion 36a and a slope portion 92b extending from the bent portion 92a to a tip and inclined in a direction along the Z-axis away from the closest surface 36b of the terminal mounting portion 36a.

Although not shown, one of lead portions (ends) of the wires 8 shown in FIG. 5 is connected to the wire connection portion 91. The mounting portion 92 is configured to be connected to a circuit pattern such as that of a circuit board 12. Thus, a coil composed of the wound portion 80 of the wire 8 is connected to an external circuit such as a circuit board 12, via each terminal 9.

As shown in FIGS. 2 to 4, in the present embodiment, the wires 8 are wound around the outer circumference of the winding core portion located between the first end flange 32 and the central flange 33 and between the central flange 33 and the second end flange 32, whereby the wound portions 80 and 80 form one or more transformers.

The wire 8 may be made of single or stranded wire such as Litz wire. The wire diameter of the wire 8 is not particularly limited and may be, for example, 0.1 to 0.4 mm. The wire 8 is made of a conductive wire such as a metal wire, but may be made of an insulated wire.

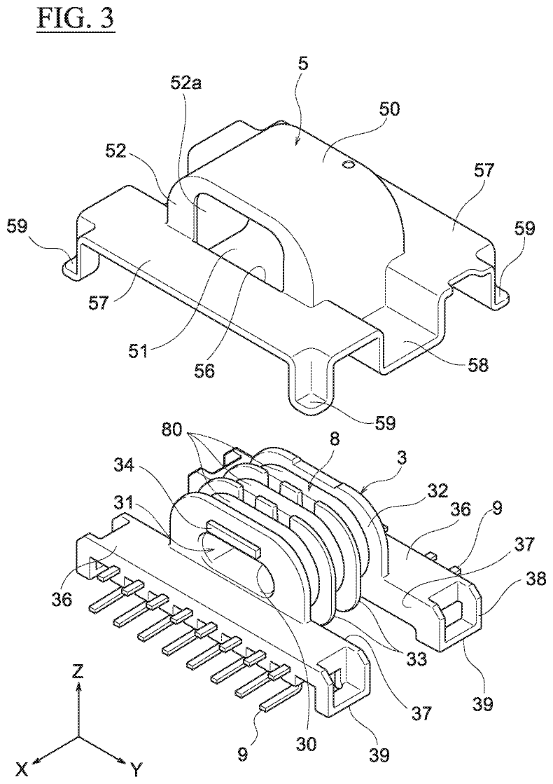

A pair of lead portions (not shown) at both ends of the wire 8 forming the wound portion 80 pass through lead passages 37a and passages between the terminal mounting portions 36a, and they are led to corresponding terminals 9, where they are connected to the wire connection portions 91 of the terminals 9. The lead passages 37a are formed between partitioning flanges 37 formed at a bottom surface of the terminal bases 36 shown in FIG. 1B. The partitioning flange 37 shown in FIG. 1B has an inner surface that is flush with an inner surface of the end flange 32, as shown in FIG. 3.

In the present embodiment, both ends along the Y-axis of each terminal base 36 extend outward beyond both ends along the Y-axis of the flanges 32 and 33. Each end is integrally formed with a first mounting-side protrusion 38 having a recessed shape and protruding downward along the Z-axis. The bottom surface along the Z-axis of the first mounting-side protrusion 38 is referred to as a first protrusion end face 39. The bottom surface of the recessed first mounting-side protrusion 38 is recessed relative to the upper surface of the terminal base 36. By forming the first mounting-side protrusion 38 in a recessed shape, the strength of the terminal base 36 is improved without increasing the weight of the bobbin 3.

The bobbin 3 including the tubular portion 30 and the terminal bases 36 is integrally formed from a plastic such as PPS, PET, PBT, LCP, or nylon, but may be made of other insulating materials. In the present embodiment, the bobbin 3 is preferably made of a plastic having a high thermal conductivity of, for example, 1 W/m. K or higher, and may be made of a material such as PPS or nylon.

As shown in FIGS. 2 and 3, the cover 5 is formed as a member separate from the bobbin 3. The cover 5 may be made of an insulating material the same as that of the bobbin 3, but is preferably made of an insulating material having higher elasticity than that of the bobbin 3, such as LCP or nylon.

The cover 5 has a cover body 50 that covers the wound portions 80 of the wires 8 wound around the outer circumferential surface of the tubular portion 30 of the bobbin 3 as well as the outer circumferences of the flanges 32 and 33 on their non-mounting-sides. The upper surface of the cover body 50 is preferably a flat surface. For example, the upper surface of the cover body 50 of the cover 5 can be held by a nozzle for mounter. An end wall 52 is integrally formed at each end along the X-axis of the cover body 50 and is formed with an end opening 51.

Each of the end walls 52 is integrally formed with the terminal-base covering portion 57 that covers the upper surface along the Z-axis of the corresponding terminal base 36. The ends along the Y-axis of each of the terminal-base covering portions 57 are integrally connected to each other by a central protrusion 58 having a recessed shape and protruding downward along the Z-axis. The bottom surface along the Z-axis of the central protrusion 58 forms a second protrusion end face 58a of a second mounting-side protrusion. The upper surface of the central protrusion 58 is recessed relative to the upper surface of the terminal-base covering portion 57 and is also integrally formed with a side wall 54 of the cover body 50. By forming the central protrusion 58 in a recessed shape, the strength of the cover 5 is improved without increasing the weight of the cover 5.

Moreover, corner protrusions 59 are integrally formed at outer ends along the X-axis (on sides opposite to the central protrusion 58) and at both ends along the Y-axis of each terminal-base covering portion 57. The corner protrusion 59 has a recessed shape and protrudes downward along the Z-axis. The bottom surface along the Z-axis of the corner protrusion 59 forms a second protrusion end face 59a of the second mounting-side protrusion. The bottom surface of the recessed corner protrusion 59 is recessed relative to the upper surface of the terminal-base covering portion 57. When viewed along the Z-axis, the corner protrusion 59 is arranged at each of the four corners of the rectangular cover 5. By forming the corner protrusion 59 in a recessed shape, the strength of the cover 5 is improved without increasing the weight of the cover 5.

The end opening 51 of the cover 5 has a larger opening area than the opening area of the through hole 31 of the bobbin 3. In a state in which the cover 5 is attached to the bobbin 3, a protrusion 34 of the bobbin 3 engages an upper edge of the end opening 51, whereby the through hole 31 is positioned within the end opening 51 at a specified position. The protrusion 34 is formed at an upper edge of the through hole 31 of the bobbin 3 so as to protrude outward along the X-axis from the end surface along the X-axis of each of the end flanges 32. The length along the Y-axis of the protrusion 34 is shorter than the length along the Y-axis of the end opening 51.

A center opening 56 is formed at a central portion of the cover 5, the central portion being surrounded by the cover body 50 and the terminal-base covering portions 57 and 57. Thus, the center opening 56 is configured to receive a top portion of the tubular portion 30 of the bobbin 3 from below along the Z-axis.

In a state in which the cover 5 is attached to the bobbin 3, the central leg portions 21 of the cores 2 enter the through hole 31 through the end openings 51. The base portions 23 of the cores 2 and root portions of the outer leg portions 22 are arranged on the upper surfaces of the terminal-base covering portions 57, and the tip portions of the outer leg portions 22 are adjacent to each other along the X-axis and abut each other above the recessed central protrusions 58.

As shown in FIG. 1A, in a state in which the cover 5 is attached to the bobbin 3 and the core 2 is attached thereto, by winding, for example, a tape 11, around the cores 2, the pair of cores 2 are combined, and the cores 2, the bobbin 3, and the cover 5 are assembled. In addition, at least a portion of the protrusion 34 of the bobbin 3 (refer to FIG. 2), the end wall 52 of the cover 5, at least a portion of the end flange 32 of the bobbin 3, and a portion of the core 2 (preferably, a portion of a boundary between the central leg portion 21 and the base portion 23) are covered with an adhesive 10, whereby the cover 5, the bobbin 3, and the core 2 are fixed. Moreover, an adhesive 10a, which is the same as or different from the adhesive 10, may be applied to the interface between the upper surface of the terminal-base covering portion 57 of the cover 5 and the tape 11, thereby fixing the tape 11 to the cover 5.

Next, an example of a method for manufacturing the coil device 1 according to the present embodiment will be described. The coil device 1 is manufactured by winding the wires 8 around the winding core portion of the bobbin 3 shown in FIG. 3, attaching the cover 5 to the bobbin 3, and then attaching the cores 2 shown in FIG. 2 to the bobbin 3.

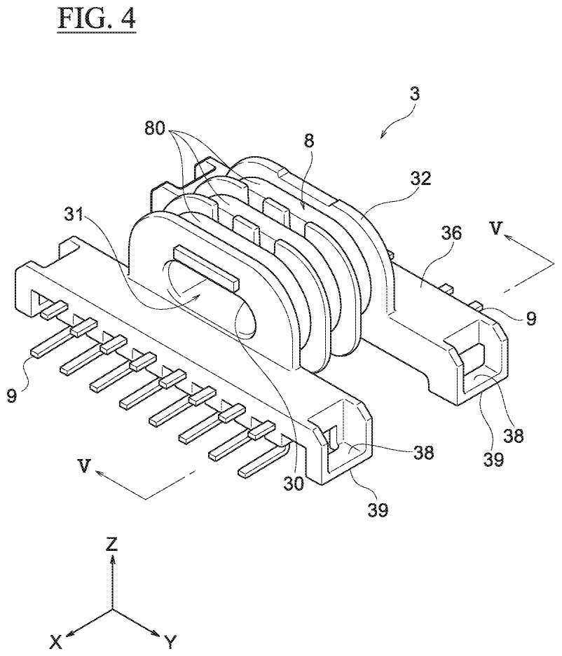

First, the bobbin 3 shown in FIGS. 3 and 4 is prepared. The bobbin 3 may be formed, for example, by injection molding, and the cover 5 may also be formed, for example, by injection molding.

Then, the wires 8 are wound around the winding core portion of the tubular portion 30 of the bobbin 3 to form the wound portions 80, and the lead portions at both ends of the wires 8 are connected to the wire connection portions 91 of the terminals 9. The method for connecting the lead portions to the wire connection portions 91 of the terminals 9 is not particularly limited. For example, crimping, thermocompression bonding, laser welding, or soldering may be used.

Next, the cover 5 shown in FIG. 3 is attached to the bobbin 3 shown in FIG. 4 from above. At this time, the cover 5 is attached to the bobbin 3 such that the top portion of the tubular portion 30 of the bobbin 3 shown in FIG. 3 is inserted into the center opening 56 of the cover 5. The protrusion 34 of the bobbin 3 passes through the end opening 51 from the center opening 56 of the cover 5 and engages the upper edge of the end opening 51. Thus, the end opening 51 formed in the cover 5 and the through hole 31 of the bobbin 3 are automatically aligned.

The central protrusion 58 of the cover 5 enters the space between end portions along the Y-axis of the pair of terminal bases 36 that are adjacent to each other along the X-axis. The corner protrusion 59 of the cover 5 is arranged to cover an outer surface along the X-axis of an end portion that is positioned along the Y-axis of each of the terminal bases 36. Thus, as shown in FIGS. 1B and 1C, the first protrusion end face 39 of the first mounting-side protrusion 38 of the bobbin 3 is arranged along the X-axis between the second protrusion end face 58a of the central protrusion 58 and the second protrusion end face 59a of the corner protrusion 59 of the cover 5.

That is, when the coil device 1 is viewed from below along the Z-axis, on each side along the Y-axis, the second protrusion end face 59a, the first protrusion end face 39, the second protrusion end face 58a, the first protrusion end face 39, and the second protrusion end face 59a are arranged in this order and continuously aligned in a row along the X-axis. The second protrusion end face 59a, the first protrusion end face 39, the second protrusion end face 58a, the first protrusion end face 39, and the second protrusion end face 59a are substantially flush with one another.

Next, with the cover 5 shown in FIG. 2 attached to the bobbin 3, the cores 2 and 2 are attached to the cover 5 from opposite directions along the X-axis. Specifically, the central leg portions 21 and 21 of the cores 2 and 2 are inserted into the through hole 31 of the bobbin 3 through the end openings 51 of the cover 5. The tips of the outer leg portions 22 and 22 of the cores 2 and 2 are positioned above the recessed central protrusions 58 of the cover 5. Thus, the cores 2 and 2 are attached to the cover 5.

The tips of the central leg portions 21 and 21 inserted into the through hole 31 may have a gap therebetween or may be in contact with each other. The tips of the outer leg portions 22 are preferably in contact with each other.

Thereafter, as shown in FIG. 1A, the tape 11 may be wrapped around the cores 2 and 2 assembled with the cover 5 to further secure the cores 2 and 2 to the cover 5 and the bobbin 3. The tape 11 is preferably an insulating tape, and for example, it may be made of a plastic or rubber tape.

Next, the adhesive 10 is applied to cover at least a portion of the protrusion 34 of the bobbin 3, at least a portion of the end wall 52 of the cover 5, and a portion of the core 2 (preferably, a portion of a boundary between the central leg portion 21 and the base portion 23 shown in FIG. 2). Preferably, a portion where the end wall 52 of the cover 5 and the protrusion 34 are closest to each other is included in a region to which the adhesive 10 is applied. The adhesive 10 is not particularly limited, but for example, an epoxy adhesive or a silicone adhesive may be used.

In the present embodiment, for example, as shown in FIG. 1A, a sufficient space is formed between a side portion of the protrusion 34 extending from the end opening 51 and the upper surface of the core 2. Thus, even if the adhesive 10 has low fluidity, the adhesive 10 can easily flow into the space. As a result, the adhesive strength among the core 2, the bobbin 3, and the cover 5 is enhanced by the adhesive 10, and resistance to vibration load applied to the coil device 1 is improved. In the present embodiment, since the strength is improved, the cover 5 can be made thinner.

In addition, an adhesive 10a, which is the same as or different from the adhesive 10, may be applied to the interface between the upper surface of the terminal-base covering portion 57 of the cover 5 and the tape 11, thereby fixing the tape 11 to the cover 5. When the tape 11 is not used, the adhesive 10a bonds and fixes the base portion 23 of the core 2 and the terminal-base covering portion 57 of the cover 5.

In the present embodiment, as shown in FIGS. 5 and 6, the bobbin 3 includes the terminal base 36 having the terminal mounting portions 36a in which the terminals 9 are embedded. The terminal base 36 of the bobbin 3 includes the first mounting-side protrusion 38 having the first protrusion end face 39 that is configured to be positioned closer to the circuit board 12 than the closest surface 36b of the terminal mounting portion 36a that is closest to the circuit board 12 among the terminal mounting portions 36a. The first protrusion end face 39 of the first mounting-side protrusion 38 functions as a bonding surface for bonding to the circuit board 12.

In the coil device 1 shown in FIG. 1A, the bobbin 3 includes the first mounting-side protrusion 38 having the first protrusion end face 39 that is configured to be positioned closer to the circuit board 12 than the closest surface 36b of the terminal mounting portion 36a, the closest surface 36b being the surface of the terminal mounting portion 36a that is closest to the circuit board 12 on which the coil device 1 is to be mounted (refer to FIGS. 5 and 6). For example, the first protrusion end face 39 is configured to protrude toward the circuit board 12 along the Z-axis from the closest surface 36b of the terminal mounting portion 36a by a protruding distance Z1. The protruding distance Z1 is not particularly limited, but is preferably equal to or greater than once, or equal to greater than twice, the thickness t1 of the terminal 9.

The closest surface 36b of the terminal mounting portion 36a is preferably configured to protrude toward the circuit board 12 from the lowermost end along the Z-axis of the wound portion 80 of the wire 8 by a protruding distance Z2. This is to prevent the outer circumference of the wound portion 80 from coming into contact with the surface of the circuit board 12. The protruding distance Z2 is not particularly limited, but is preferably approximately equal to the protruding distance Z1 and may be greater than the protruding distance Z1.

In the present embodiment, it is possible to fix the gap between the first protrusion end face 39 and the circuit board 12 with an adhesive. This reinforces the electrical connection between the mounting portion 92 of the terminal 9 and a land pattern or the like on the circuit board 12, thereby improving the fixing strength therebetween. Accordingly, even when the coil device 1 is used in a portion where severe vibrations are applied, reliable connection of the coil device 1 is maintained.

After the mounting portion 92 of the terminal 9 is connected to a land pattern of the circuit board 12 by soldering, conductive adhesive, or the like, the first protrusion end face 39 may be bonded to a portion other than the land pattern with an adhesive, or vice versa. That is, after the first protrusion end face 39 is bonded to a portion other than the land pattern of the circuit board 12 with an adhesive, the mounting portion 92 of the terminal 9 may be connected to the land pattern by soldering, conductive adhesive, or the like. In each of these methods, the bonding strength to the object is sufficiently high during reflow and after the coil device 1 is mounted on the board, and therefore, the coil device 1 is maintained at the correct position.

In the present embodiment, as shown in FIGS. 5 and 6, the mounting portion 92 of the terminal 9 has the bent portion 92a protruding from the closest surface 36b of the terminal mounting portion 36a and the slope portion 92b extending from the bent portion 92a to the tip and inclined in a direction away from the closest surface 36b. The tip of the mounting portion 92 is configured to protrude toward the circuit board 12 beyond the first protrusion end face 39 by a predetermined distance Z3. With this structure, when the mounting portion 92 of the terminal 9 is connected to a land pattern of the circuit board 12 by soldering, conductive adhesive, or the like, the first protrusion end face 39 can be easily bonded to a portion other than the land pattern of the circuit board 12 with an adhesive.

In the present embodiment, the tip of the mounting portion 92 is configured to protrude toward the circuit board 12 beyond the first protrusion end face 39 by the predetermined distance Z3, so that the tip can become flush with the first protrusion end face 39 when subjected to an external force. The terminal 9 is made of a conductive metal member, and therefore, the mounting portion 92 of the terminal 9 is elastic. Thus, the tip of the mounting portion 92 can become flush with the first protrusion end face 39 due to the elasticity of the mounting portion 92 when subjected to an external force. The predetermined distance Z3 is not particularly limited and may be equal to or greater than the thickness t1 of the terminal 9, and is preferably less than the thickness t1.

In the present embodiment, the first protrusion end face 39 may protrude toward the circuit board 12 beyond the bent portion 92a. With this structure, the tip of the mounting portion 92 can slightly protrude toward the circuit board 12 beyond the first protrusion end face 39 by the predetermined distance Z3.

In the present embodiment, the first mounting-side protrusion 38 is formed at each end portion along the longitudinal direction (Y-axis) of the terminal base 36. With this structure, the positions where the terminals 9 are connected to a land pattern or the like on the circuit board 12 and the positions where the first mounting-side protrusions 38 of the bobbin 3 are bonded to the circuit board 12 can be easily made different from each other, which facilitates each connection step.

In the present embodiment, as shown in FIG. 2, the cover 5 is also used to cover the non-mounting-side outer circumference of the wound portions 80 of the wires 8 wound around the tubular portion 30 of the bobbin 3. As shown in FIG. 6, the cover 5 includes the central protrusions 58 and the corner protrusions 59 that serve as the second mounting-side protrusions configured to protrude toward the circuit board 12 beyond the mounting-side outer circumference of the wound portions 80 of the wires 8. The second protrusion end faces 58a and 59a of the central protrusion 58 and the corner protrusion 59 can also function as bonding surfaces for bonding to the circuit board 12 as with the first protrusion end face 39, thereby further improving the bonding strength to the circuit board 12.

The second protrusion end faces 58a and 59a of the central protrusion 58 and the corner protrusion 59 are arranged to be substantially flush with the first protrusion end face 39. The state of being substantially flush means that a slight deviation is acceptable within a manufacturing tolerance. The first protrusion end face 39 is formed on the bobbin 3, for which manufacturing errors are relatively more strictly controlled compared with the cover 5. Thus, in order to reliably bond the first protrusion end face 39 to the circuit board 12, the first protrusion end face 39 may protrude toward the circuit board 12 beyond the second protrusion end faces 58a and 59a by the predetermined distance Z4.

Alternatively, in view of reliably bonding the second protrusion end faces 58a and 59a to the circuit board 12, the second protrusion end faces 58a and 59a may protrude toward the circuit board 12 beyond the first protrusion end face 39. The predetermined distance Z4 is not particularly limited, but is preferably within +t1 (including zero). The symbol t1 refers to the dimension corresponding to the thickness of the terminal 9, as shown in FIG. 6.

As shown in FIGS. 1B, 1C, and 1D, the second protrusion end faces 58a and 59a are arranged adjacent to the first protrusion end faces 39 along the X-axis. This arrangement enables the continuous formation of bonding surfaces on the second protrusion end faces 58a and 59a and the first protrusion end faces 39, which improves the bonding strength.

In the present embodiment, the total area of the second protrusion end faces 58a and 59a is larger than that of the first protrusion end faces 39. As shown in FIG. 2, the cover 5 covers the non-mounting-side portions of the bobbin 3, and therefore, portions of the cover 5 positioned in spaces formed between portions forming the bobbin 3 can be used as recessed protrusions 58 and 59 that enter the spaces of the bobbin 3. This enables easily increasing the area of the second protrusion end face 58a.

Moreover, in the present embodiment, the second mounting-side protrusion includes the corner protrusion 59 that is provided at each of the four corners of the cover 5. With this structure, a reliable bonding surface is easily formed on the cover 5 while saving space without increasing the dimensions of the coil device 1.

In the present embodiment, the second mounting-side protrusion also includes the central protrusion 58 that is positioned between the pair of corner protrusions 59 and 59 arranged along the core axis (X-axis) of the wound portion 80 of the wire 8. In addition, the first mounting-side protrusion 38 is arranged between each of the pair of corner protrusions 59 and 59 and the central protrusion 58. With this structure, a continuous bonding surface is formed in a region where the first protrusion end faces 39 and the second protrusion end faces 58a and 59a are alternately arranged along the core axis (X-axis) of the wound portion 80 of the wire 8, thereby improving the bonding strength.

The area of the second protrusion end face 58a of the central protrusion 58 is larger than that of the second protrusion end face 59a of the corner protrusion 59 and is also larger than the total area of the first protrusion end faces 39. With this structure, a reliable bonding surface is easily formed on the cover 5 while saving space without increasing the dimensions of the coil device 1.

### Second Embodiment

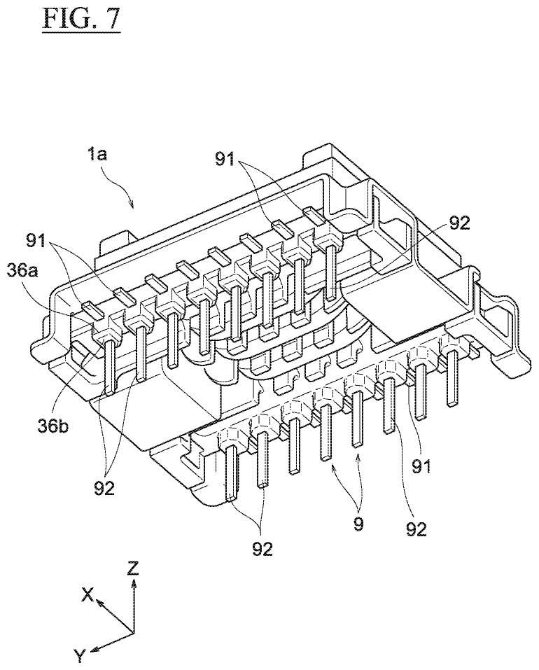

FIG. 7 shows a coil device 1a according to another embodiment. The coil device 1a differs from the coil device 1 of the embodiment shown in FIGS. 1A to 6 only in the structure of the terminals 9, and other elements are the same as or similar to those of the above-described embodiment and have substantially the same functions and advantageous effects. Therefore, description of common portions will be omitted as appropriate, and differences will be mainly described.

The mounting portion 92 of the terminal 9 of the coil device 1a extends linearly along the Z-axis from the closest surface 36b of the terminal mounting portion 36a. A circuit board (not shown) that is an object on which the coil device 1a is to be mounted is formed with a hole for inserting the pin-shaped mounting portion 92. Thus, the mounting portion 92 is configured to be connected to a land pattern or the like formed on a surface or a back surface of the circuit board.

### Third Embodiment

The coil device according to the present embodiment differs from the coil device 1 of the embodiment shown in FIGS. 1A to 6 or the coil device 1a of the embodiment shown in FIG. 7 in that the terminal base 36 of the bobbin 3 does not include the first mounting-side protrusion 38 having the first protrusion end face 39.

Therefore, description of common portions will be omitted as appropriate, and differences will be mainly described.

This coil device has substantially the same functions and advantageous effects as those of the above-described embodiments except that the first protrusion end face 39 does not provide an adhesive bonding function with respect to the circuit board 12.

### Fourth Embodiment

The coil device according to the present embodiment differs from the coil device 1 of the embodiment shown in FIGS. 1A to 6 or the coil device 1a of the embodiment shown in FIG. 7 in that the cover 5 does not include one or both of the second protrusion end faces 58a and 59a. Therefore, description of common portions will be omitted as appropriate, and differences will be mainly described.

This coil device has substantially the same functions and advantageous effects as those of the above-described embodiments except that one or both of the second protrusion end faces 58a and 59a do not provide an adhesive bonding function with respect to the circuit board 12.

The present disclosure is not limited to the above-described embodiments and can be variously changed and modified within the scope of the present disclosure.

For example, the terminal base 36 may be formed as a member separate from the bobbin 3. The object on which the coil device 1 or 1a is mounted is not limited to the circuit board 12 and may be other substrates or members.

### REFERENCE SIGNS LIST

1, 1a . . . coil device
2 . . . core
21 . . . central leg portion
22 . . . outer leg portion
23 . . . base portion
23a . . . recess
3 . . . bobbin
30 . . . tubular portion
31 . . . through hole
32 . . . end flange
33 . . . central flange
34 . . . protrusion
36 . . . terminal base
36a . . . terminal mounting portion
36b . . . closest surface
37 . . . partitioning flange
38 . . . first mounting-side protrusion
39 . . . first protrusion end face
5 . . . cover
50 . . . cover body
51 . . . end opening
52 . . . end wall
54 . . . side wall
56 . . . center opening
57 . . . terminal-base covering portion
58 . . . central protrusion (second mounting-side protrusion)
58a . . . second protrusion end face
59 . . . corner protrusion (second mounting-side protrusion)
59a . . . second protrusion end face
8 . . . wire
80 . . . wound portion
91 . . . wire connection portion
92 . . . mounting portion
93 . . . bent portion
10, 10a . . . adhesive
11 . . . tape
12 . . . circuit board (object)

What is claimed is:

1. A coil device comprising:
a bobbin including a tubular portion, a wire being wound around a tubular portion; and
a terminal connected to an end of the wire wound around the tubular portion, wherein
the bobbin includes a terminal mounting portion to which the terminal is attached,
the bobbin comprises a first mounting-side protrusion having a first protrusion end face located closer to an object on which the coil device is to be mounted than a closest surface of the terminal mounting portion that is closest to the object, and
the first protrusion end face functions as a bonding surface for bonding to the object.

2. The coil device according to claim 1, wherein the first protrusion end face protrudes outward toward the object on which the coil device is to be mounted beyond the terminal mounting portion that holds a mounting portion of the terminal.

3. The coil device according to claim 2, wherein the mounting portion of the terminal comprises:
a bent portion protruding from the terminal mounting portion; and
a slope portion extending from the bent portion to a tip of the bent portion and inclined in a direction away from the terminal mounting portion, and
the tip of the mounting portion protrudes toward the object on which the coil device is to be mounted beyond the protrusion end face.

4. The coil device according to claim 3, wherein the tip of the mounting portion protrudes beyond the first protrusion end face toward the object on which the coil device is to be mounted, so as to be flush with the first protrusion end face when the tip of the mounting portion receives an external force.

5. The coil device according to claim 3, wherein the first protrusion end face protrudes beyond the bent portion toward the object on which the coil device is to be mounted.

6. The coil device according to claim 2, wherein a terminal base is integrally formed with the bobbin and has the terminal mounting portion, and the first mounting-side protrusion is formed on the terminal base at an end portion along a longitudinal direction of the terminal base.

7. The coil device according to claim 1, further comprising a cover that covers a non-mounting-side outer circumference of a wound portion of the wire wound around the tubular portion, and the cover includes a second mounting-side protrusion that protrudes beyond a mounting-side outer circumference of the wound portion of the wire toward the object on which the coil device is to be mounted.

8. The coil device according to claim 7, wherein the second mounting-side protrusion has a second protrusion end face that is arranged to be substantially flush with the first protrusion end face.

9. The coil device according to claim 8, wherein the second protrusion end face is arranged adjacent to the first protrusion end face.

10. The coil device according to claim 8, wherein the total area of the second protrusion end faces is larger than the total area of the first protrusion end faces.

11. The coil device according to claim 8, wherein the second mounting-side protrusion includes corner protrusions, each provided at a corresponding one of four corners of the cover.

12. The coil device according to claim 11, wherein the second mounting-side protrusion also includes a central protrusion positioned between a pair of the corner protrusions arranged along a core axis of the wound portion of the wire, and a portion of the first mounting-side protrusion is arranged between the central protrusion and one of the pair of corner protrusions.

13. The coil device according to claim 12, wherein the second protrusion end face and the first protrusion end face are arranged alternately in a direction along the core axis of the wound portion of the wire.

14. The coil device according to claim 12, wherein the area of an end face of the central protrusion is larger than the total area of end faces of the corner protrusions and is also larger than the total area of the first protrusion end faces.

15. A coil device comprising:
a bobbin including a tubular portion, a wire being wound around a tubular portion;
a cover covering a non-mounting-side outer circumference of a wound portion of the wire wound around the tubular portion; and
a terminal connected to an end of the wire wound around the tubular portion, wherein
the bobbin includes a terminal mounting portion to which the terminal is attached,
the cover comprises a second mounting-side protrusion having a second protrusion end face located closer to an object on which the coil device is to be mounted than a closest surface of the terminal mounting portion that is closest to the object, and
the second protrusion end face functions as a bonding surface for bonding to the object on which the coil device is to be mounted.

16. The coil device according to claim 15, wherein the second mounting-side protrusion includes corner protrusions respectively provided at corners of the cover.

17. The coil device according to claim 16, wherein the second mounting-side protrusion also includes a central protrusion that is positioned between a pair of the corner protrusions arranged along a core axis of the wound portion of the wire.

18. The coil device according to claim 15, wherein the second mounting-side protrusion is integrally formed with a terminal-base covering portion of the cover that covers an upper surface of a terminal base having the terminal mounting portion and is recessed from the terminal-base covering portion toward the object on which the coil device is to be mounted.
